(19) United States
(12) Patent Application Publication
(10) Pub. No.: US 2005/0204127 A1
(43) Pub. Date: Sep. 15, 2005

(54) Mobile wireless device with protected file system

(76) Inventors: Corinne Dive-Reclus, Herts (GB); Andrew Thoelke, Middlesex (GB); Mark Dowman, Oxon (GB)

Correspondence Address: Richard C Woodbridge;Synnestvedt Lechner & Woodbridge, PO Box 592, Princeton, NJ, 08542-0592, US

(21) Appl. No.: 10/515,759

(22) PCT Filed: May 28, 2003
(86) PCT No.: PCT/GB03/02313

§ 371 Date: Nov. 24, 2004

(30) Foreign Application Priority Data
May 28, 2002 (GB) 0212315.6

(51) Int. Cl. G06F 7/00

(52) U.S. Cl. 713/152; 707/9

(57) ABSTRACT

A mobile wireless device programmed with a file system which is partitioned into multiple root directories. The partitioning of the file system ‘cages’ processes as it prevents them from seeing any files they should not have access to. A Trusted Computing Base verifies whether or not a process has the required privileges or capabilities to access root sub-trees. The particular directory a file is placed into automatically determines its accessibility to different processes—i.e. a process can only access files in certain root directories. This is a light weight approach since there is no need for a process to interrogate an access control list associated with a file to determine its access rights over the file—the location of the file taken in conjunction with the access capabilities of a process intrinsically define the accessibility of the file to the process. Another aspect of this invention is that each process can have its own private area of the file system guaranteeing confidentiality and integrity to its data.

### FIELD OF THE INVENTION

This invention relates to a mobile wireless device with a protected file system. The protected file system forms an element in a platform security architecture.

DESCRIPTION OF THE PRIOR ART

Platform security covers the philosophy, architecture and implementation of platform defence mechanisms against malicious or badly written code. These defence mechanisms prevent such code from causing harm. Malicious code generally has two components: a payload mechanism that does the damage and a propagation mechanism to help it spread. They are usually classified as follows:

Trojan horse: poses as a legitimate application that appears benign and attractive to the user.

Worm: can replicate and spread without further manual action by their perpetrators or users.

Virus: Infiltrates legitimate programs and alters or destroys data.

Security threats encompass (a) a potential breach of confidentiality, integrity or availability of services or data in the value chain and integrity of services and (b) compromise of service function. Security threats are classified into the following categories:

1. Threats to confidentiality and integrity of data. Examples: Get users password; corrupt files.

2. Threats to confidentiality and integrity of services. Examples: Use bandwidth from phone network subscriber without paying for it; repudiate transaction with network service provider.

3. Threats to availability of service (also called denial of service). Examples: Prevent the user from sending a text message; prevent the user from accepting a telephone call.

Hence, mobile wireless devices offer very considerable challenges to the designer of a security architecture. One critical aspect of this challenge is to efficiently protect the file system to prevent malicious applications reading confidential data (e.g. PINs etc) and to preserve the integrity of the file system. To date, there have however been no efficient proposals for protecting the file system of a mobile wireless device.

### SUMMARY OF THE PRESENT INVENTION

In a first aspect of the present invention, there is a single user mobile wireless device programmed with a file system which is partitioned into multiple root directories, in which the location of a file is enough to fully define its access policy to a process running on the device (i.e. to define which processes can access the file). The partitioning of the file system in this way ‘cages’ processes as it prevents them from seeing any files they should not have access to. (Once a program containing native executable code is loaded in memory, it becomes a ‘process’; the process is therefore the running memory image of a program containing native executable code which is stored onto the file system). Trusted components, such as a ‘Trusted Computing Base’ (which should be understood as covering architectural elements that cannot be subverted and that guarantee the integrity of the device; see Detailed Description section 1.1. for an implementation) verify whether or not a process has the required privileges or ‘capabilities’ (see Detailed Description at section 2 for an explanation of ‘capabilities’) to access rood sub-trees (e.g. files in a sub-directory).

As noted above, a secure operating system must control access to the file system to ensure its own integrity, as well as user data confidentiality. With the present invention, a particular directory a file is places into automatically determines its accessibility to different process—i.e. a process can only access files in certain root directories. This is a light weight approach since their is no need for a process to interrogate an access control list associated with a file to determine its access rights over the file—the location of the file taken in conjunction with the access capabilities of a process intrinsically define the accessibility of the file to the process. Moving the location of a file in the file system (e.g. between root directories) can therefore modify the access policy of that file.

Each process may also have its own private area of the file system guaranteeing confidentiality and integrity of its data.

With one of the possible implementations of the present invention (called implementation A in the rest of the document), a file is placed into a location within a file system with 4 types of root directories (or their functional equivalents);

/system

/private/<process_secure_id>

/resources

/<others>

/system is accessible by any process that has been granted Root operating system privilege or capability (the concept of ‘capability’ is discussed in the Detailed Description section 2). Only processes assigned a ‘Root’ or ‘AllFiles’ capability can see files in the /system sub-tree and only processes assigned Root can modify them

/private/<process_secure_id> is available to any processes having their secure identifier assigned to process secure_id, as well as processes that have been granted ‘Root’ or ‘AllFiles’ capability. The SID (secure identifier) of a process is a way of uniquely identifying a piece of code capable of running on the OS and is stored in the related executable. This executable is stored under/system and therefore cannot be modified by processes without Root operating system privilege. When a process tries to access a file, the file system server will check its SID and its privileges to decide to grant or deny access.

/resources is public read only; only the Trusted Computing Base TCB) can add/remove/modify. The TCB comprises in one implementation the kernel, loader, file server and software installer.

/others> is available to any process for file read and write operations, file creation and deletion.

In another implementation, there is an ‘open’ mobile wireless device programmed with a software installer that is responsible for installing new applications and their files without compromising the integrity of the existing file system. It would create or update files according to their types, their location (public directories) and the secure identifier (SID) of the programs (see Detailed Description at 3.3)

In another aspect, there is an operating system comprising a file installation mechanism to allow programs to contribute to another program's private directory without compromising it (see Detailed Description at 3.3)

### DETAILED DESCRIPTION

The present invention will be described with reference to the security architecture of the Symbian OS object oriented operating system, designed for single user wireless devices. The Symbian operating system has been developed for mobile wireless devices by Symbian Ltd, of London, United Kingdom.

The basic outline of the Symbian OS security architecture is analogous to a medieval castle's defences. In a similar fashion, it employs simple and staggered layers of security above and beyond the installation perimeter. The key threats that the model is trying to address are those that are linked with unauthorised access to user data and to system services, in particular the phone stack The phone stack is especially important in the context of a smart phone because it will be controlling a permanent data connection to the phone network There are two key design drivers lying behind the model:

Firewall protection of key system resources through the use of capability-based access control.

Data partitioning which creates a protected part of the file system which standard software is not able to access.

The main concept of the capability model described below is to control what a process can do rather than what a user can do. This approach is quite different to well-known operating systems as Widows NT and Unix. The main reasons are:
The very nature of Symbian OS is to be mono-user.

Symbian OS provides services through independent server processes. They always run and are not attached to a user session. As long as power is supplied, Symbian OS is always on even if no user is logged on.

Symbian OS is aimed to be used in devices used by a large public with no technology knowledge. When installing software, the user may not have the skills to decide what permissions to grant to an application. Furthermore, with always-connected devices, the consequences of a wrong or malevolent decision may impact a domain much larger than the device itself.

1 Trusted Computing Platform

1.1 Trusted Computing Base

A trusted computing base (TCB) is a basic architectural requirement for robust platform security. The trusted computing base consists of a number of architectural elements that cannot be subverted and that guarantee the integrity of the device. It is important to keep this base as small as possible and to apply the principle of least privilege to ensure system servers and applications do not have to be given privileges they do not need to function. On closed devices, the TCB consists of the kernel, loader and file server; on open devices the software installer is also required. All these processes are system-wide trusted and have therefore full access to the device file system. This trusted core would run with a “Root” capability not available to other platform code (see section 2.1).

There is one other important element to maintain the integrity of the trusted computing base that is out of the scope of this invention, namely the hardware. In particular, with devices that hold trusted computing base functionality in flash ROM it is necessary to provide a secure boot loader to ensure that it is not possible to subvert the trusted computing base with a malicious ROM image.

1.2 Trusted Computing Environment

Beyond the core, other system components would be granted restricted orthogonal system capability and would constitute the Trusted Computing Environment (TCE); they would include system servers such as socket, phone and window servers. For instance the window server would not be granted the capability of phone stack access and the phone server would not be granted the capability of direct access to keyboard events. It is strongly recommended to give as few system capabilities as possible to a software component to limit potential damage by any misuse of these privileges.

The TCB ensures the integrity of the full system as each element of the TCE ensures the integrity of one service. The TCE cannot exist without a TCB but the TCB can exist by itself to guarantee a safe “sand box” for each process.

2 Process Capabilities

A capability can be thought of as an access token that corresponds to a permission to undertake a sensitive action. The purpose of the capability model is to control access to sensitive system resources. The most important resource that requires access control is the kernel executive itself and a system capability (see section 2.1) is required by a client to access certain functionality through the kernel API. All other resources reside in user-side servers accessed via IPC [Inter Process Communication]. A small set of basic capabilities would be defined to police specific client actions on the servers. For example, possession of a mike a capability would allow a client to use the phone server. It would be the responsibility of the corresponding server to police client access to the resources that the capability represents. Capabilities would also be associated with each library DLL) and program (EXE) and combined by the loader at run time to produce net process capabilities that would be held by the kernel. For open devices, third party software would be assigned capabilities either during software installation based on the certificate used to sign their installation packages or post software installation by the user. The policing of capabilities would be managed between the loader, the kernel and affected servers but would be kernel-mediated through the IPC mechanism.

The key features of the process capability model are:

It is primarily focused around system servers and client-server IPC interactions between these entities.

Capabilities are associated with processes and not threads. Threads in the same process share the same address space and memory access permissions. This means that any data being used by one thread can be read and modified by all other threads in the same process.

The policing of the capabilities is managed by the loader and kernel and through capability policing at the target servers. The kernel IPC mechanism is involved in the latter.

When the code is not running, capabilities are stored inside of libraries and programs. Capabilities stored in libraries and programs are not modifiable, as they would be stored during installation in a location that is only accessible by the Trusted Computing Base.

Not all servers would have to handle client capabilities. Servers would be responsible for interpreting capabilities as they wish.

The only cryptography involved in this scheme might be at the software installation stage where certificates would be checked off against a suitable root certificate.

2.1 System Capabilities: Protecting the Integrity of the Device

Root. “Full access to all files—Can modify capabilities associated with executables”
“Root” capability—Used by the Trusted Computing Base only, it gives full access to all files in the device.
   System Capabilities

Some system servers require some specific access to the Trusted Computing Base. Because of the object-oriented implementation of Symbian OS, the kind of resources required by a system server is most of the time exclusive to it. Therefore, one system server would be granted some system capability that would be orthogonal to those required by another. For instance, the window server would be granted access to keyboard and pen events issued by the kernel but it would not have permission to access the phone stack In the same way, the phone server would be granted access to the phone stack but would not have permission to collect events from the kernel. As examples, we can name:

| | |
|---|---|
| WriteSystemData | Allows modification of configuration system data |
| CommDD | Grants access to all communication and Ethernet card |
| | device drivers. |
| DiskAdmin | Can perform administration task on the disk (reformat, |
| | rename a drive, . . . ). |

2.2 User-Exposed Capabilities: Mapping Real-World Permissions

The process of generating capabilities can be difficult. One has first to identify those accesses that require policing and then to map those requirements into something that is meaningful for a user. In addition, more capabilities means greater complexity and complexity is widely recognised as being the chief enemy of security. A solution based on capabilities should therefore seek to minimise the overall number deployed. The following capabilities map fairly broadly onto the main threats which are unauthorised access to system services (eg. the phone stack) and preserving the confidentiality/integrity of user data.

PhoneNetwork. “Can access phone network services and potentially spend user money”
“Make telephone calls”
“Send short text messages”.

WriteUserData. “Can read and modify users private information”
“Add a contact”.
“Delete an appointment”.

ReadUserData. “Can read users private information”
“Access contacts data”.
“Access agenda data”.

LocalNetwork. “Can access local network”
“Send Bluetooth messages”.
“Establish an IR connection”
“Establish an USB connection”

Location. “Can access the current location of the device”
“Locate the device on a map”
“Display closest restaurants and cinema”

Root and system capabilities are mandatory; if not granted to an executable, the user of the device cannot decide to do it. Their strict control ensures the integrity of the Trusted Computing Platform. However the way servers check user-exposed capabilities or interpret them maybe fully flexible and even user-discretionary.

2.3 Assigning Capabilities to a Process

The association of a run-time capability with a process involves the loader. In essence, it transforms the static capability settings associated with individual libraries and programs into a run-time capability that the kernel holds and can be queried through a kernel user library API.

The loader applies the following rules:

Rule 1. When creating a process from a program, the loader assigns the same set of capabilities as its program's.

Rule 2. When loading a library within an executable, the library capability set must be greater than or equal to the capability set of the loading executable. If not true, the library is not loaded into the executable.

Rule 3. An executable can load a library with higher capabilities, but does not gain capabilities by doing so.

Rule 4. The loader refuses to load any executable not in the data caged part of the file system reserved to the TCB.

It has to be noted that:

Libraries' capabilities are checked at load time only. Beyond that, all code contained in libraries is run freely and is assigned the same capability set as the program it runs into when initiating some IPC calls.

For ROM images with execution in place, the ROM build tool resolves all symbols doing the same task as the loader at runtime. Therefore the ROM build tool must enforce the same rules as the loader when building a ROM image.

These rules

Prevent malware from being loaded in sensitive processes, for example, a plug-in in a system server

Encourage encapsulation of sensitive code inside processes with no possible bypass The examples below show how these rules are applied in the cases of statically and dynamically loaded libraries respectively.

2.3.1 Examples for Linked DLLs

The program P.EXE is linked to the library L1.DLL.

The library L1.DLL is linked to the library L0.DLL.

Case 1:
P.EXE holds Cap1 & Cap2
L1.DLL holds Cap1 & Cap2 & Cap3
L0.DLL holds Cap1 & Cap2
Process P cannot be created, the loader fails it because L1.DLL cannot load L0.DLL. Since L0.DLL does not have a capability set greater than or equal to LL1DLL, Rule 2 applies.

Case 2:
P.EXE holds Cap1 &Cap2
L1.DLL holds Cap1& Cap2 & Cap3
L0.DLL holds Cap1 & Cap2 & Cap3 & Cap4
Process P is created, the loader succeeds it and the new process is assigned Cap1 & Cap2. The capability of the new process is determined by applying Rule 1; L1.DLL cannot acquire the Cap4 capability held by L0.DLL, and P1.EXE cannot acquire the Cap3 capability held by L1.DLL as defined by Rule 3.

2.3.2 Examples for Dynamically Loaded DLLs The program P.EXE dynamically loads the library L1.DLL. The library L1.DLL then dynamically loads the library L0.DLL.

Case 1:
P.EXE holds Cap1 & Cap2
L1.DLL holds Cap1 & Cap2 & Cap3
L0.DLL holds Cap1 & Cap2
Process P is successfully created and assigned Cap1 & Cap2.
When P requests the loader to load L1.DLL & L0.DLL, the loader succeeds it because P can load L1.DLL and L0.DLL. Rule 2 does apply here the loading executable being the process P not the library L1.DLL: the IPC load request that the loader processes is sent by the process P. The fact that the call is within L1.DLL is here irrelevant. Rule 1 & 3 apply as before and P does not acquire Cap3 by loading L1.DLL

Case 2:

P.EXE holds Cap1 & Cap2
L1.DLL holds Cap1&Cap2&Cap3
L0.DLL holds Cap1&Cap2&Cap4
Process P is successfully created and assigned Cap1 & Cap2. When P requests the loader to load L1.DLL & L0.DLL, the loader succeeds it because P can load L1.DLL and L0.DLL. Once again, Rule 2 does apply with P as the loading executable rather than L1.DLL, while Rule 3 ensures P acquires neither Cap3 nor Cap4.

3 Caging processes

3.1 Location-based concept

Data partitioning involves separating code from data in the file system such that a simple trusted path is created on the platform. The central idea of the present invention is that by “caging” non-TCB processes into their own part of the file system, sensitive directories become hidden to them. In implementation A, the /system directory becomes hidden to ordinary processes; the kernel and the file server would check that a client process had Root or AllFiles capability before allowing any access to the /system sub-tree. All other clients would have their own restricted view on the file system which would consist of the sub-tree below a special private directory which would be /private/<app_SID>, / resources and /<others>. In addition, the loader would disallow any attempt to execute code not residing in /system.

SIDs (Secure Identifiers) would be used to distinguish between the sub-tree directories. Applications for example would use their sub-tree to hold their own resource files. In essence, data partitioning involves caging processes into their own small part of the file system. This means that there is default protection of per-application and per-server data from other processes. Without partitioning, it would become necessary to introduce access control lists into the file system to prevent rogue programs bypassing the capability model and simply reading databases directly from files. In addition, the scheme affords further protection against the threat of malicious replacement of system plug-ins in the TCB reserved directory (/system in implementation A). An analogy may be made with memory management; currently only the kernel has an unrestricted view of the real machine memory. Each process has its own view of the processor's address space that is independent of all other processes. This is arranged and policed by the kernel and the memory management unit i; any access outside the range of one process memory space is rejected.

In that sense, partitioning is a simple and robust solution:
The location of a file is sufficient to fully describe its access rules. No extra information is required.
Its rules can be modified only if its location can be modified.
Each process is granted a private area, which guarantees confidentiality and integrity of its data.

For simplicity the file system is not aware of the meaning of “private user data” and “system data”. A file cannot be flagged as so. It is the responsibility of each server and application to manage ReadUserData/WriteUserData and ReadSystemData/WriteSystemData capabilities when required. For example, if a user wants to identify a word processor document as private, she can password-protect it, making ReadUserData unnecessary to access the encrypted file. Furthermore in case of databases, the file itself can contain system, user and public data and therefore trying to assign a level of privacy to a file is inappropriate.

An example of a preferred implementation is given by implementation A; each file system is partitioned in 4 types of root directories:
/system
/private/<processsecureid>
/resources
/others>
/system is accessible by the TCB or processes with AUlFiles. Only the TCB can modify them.
/private/<process_secure_id> is available to any process having their secure identifier assigned to processsecureid as well as processes that have been granted ‘Root’ or ‘AllFiles’.
/resources is public read only, only the Trusted Computing Base (TCB) can add/remove/modify.
<others> is available to any process for file read and write operations, file creation and deletion.

3.2 Secure Identifier(SID) Concept

As described above, a process can get access to a private directory only if its SID matches the name of the private directory. It is not excluded, in order to support processes with strong coupling, for a set of processes to be given the same SID. In this case, all processes with the same SID may share the same private directory. However, it has to be noted this concept is very different from the concept of group: one process can have only one SID, it cannot be part of more than one security domain. Therefore the implementation of data caging must stay ignorant of the nature of SIDs.

3.3 Software Installer

1. On open devices, at application install time, the structuring of the file system would be done by the software installer which would deposit the corresponding application files into directories according to the rules of the chosen implementation. In implementation A, programs and libraries complete with their capabilities must be in /system.

2. Any file in a public (read-only or not) directory can be installed

3. Any file in a private directory can be installed if the application to install has the same SID as the private directory the file should be put in.

4. Any file in an import directory of a process private directory can be installed if the import directory exists. In implementation A, this import directory is /private/process_sid/import.

5. No existing files on the device must be overwritten by the package to be installed if this one has not been identified as an upgrade of the original package that would have created the file. The definition of an upgrade is out of the scope of this invention, as it does not affect the aspects of this invention.

It is important to understand that rule 4) does not run counter to the principles of data caging: the installed application will not be able to access this file once installed. The presence of an import directory in the private area of a process notifies the possibility for another application to make a contribution to this process at install time. A good example would be a font server all fonts would be stored in the private directory of the font server. However external application packages could contribute by adding new fonts without polluting the server's private directory as they would be all under the import directory clearly stating their external origin.

1. A single-user mobile wireless device programmed with a file system which is partitioned into multiple root directories; in which the location of a file is enough to fully identify its access policy to a process running on the device.

2. The device of claim 1 in which access rights of the file are modified by moving its location in the file system.

3. The device of claim 1 in which one of the root directories is reserved to components forming a Trusted Computing Base.

4. The device of claim 1 in which one or more trusted components verify whether or not a process has the required privileges or capabilities to access a file system sub-tree.

5. The device of claim 1 in which a process is restricted to accessing only its own private area of the file system.

6. The device of claim 5 in which the private area is accessible only to a process with a correct secure identifier.

7. The device of claim 1 in which the root directories are each functionally equivalent to the following:
(a) a root directory with sub-trees accessible to any process that has been granted operating system privileges over all files;
(b) a root directory with sub-trees accessible only to a process with a correct secure identifier;
(c) a root directory with sub-trees that are public read-only,
(d) a root directory with sub-trees that are available to any process for file read and write operations, file creation and deletion.

8. A single user operating system for a mobile wireless device, the operating system comprising a file insulation mechanism that maintains the integrity of an exiting file system by controlling where files are installed, the file system being portioned into multiple root directories; in which the location of a file is enough to fully identify its access policy to a process running on the device.

9. The operating system of claim 8 in which access rights of the file are modified by moving it location in the file system.

10. The operating system of claim 8 in which one of the root directories is reserved to components forming a Trusted Computing Base.

11. The operating system of claim 8 in which one or more trusted components verify whether or not a process has the required privileges or capabilities to access a file system sub-tree.

12. The operating system of claim 8 in which a process is restricted to accessing only its own private area of the file system.

13. The operating system of claim 12 in which the private area is accessible only to a process with a correct secure identifier.

14. The operating system of claim 8 in which the file installation mechanism allows program to contribute to another program's private are without compromising it.

15. The operating system of claim 8 in which the root directories are each functionally equivalent to the following.
(a) a root directory with sub-trees accessible to any process that has been granted operating system privileges over all files;
(b) a root directory with sub-trees accessible only to a process with a correct secure identifier;
(c) a root directory with sub-trees that are public read-only;
(d) a root directory with sub-trees that are available to any process for file read and write operations, file creation and deletion.
